(19) United States
(12) Patent Application Publication
(10) Pub. No.: US 2008/0135523 A1
(43) Pub. Date: Jun. 12, 2008

(54) Self-blast circuit breaker with control body

(75) Inventors: Martin Seeger, Zurich (CH); Lutz Niemeyer, Birr (CH)

Correspondence Address: BUCHANAN, INGERSOLL & ROONEY PC, POST OFFICE BOX 1404, ALEXANDRIA, VA, 22313-1404, US

(73) Assignee: ABB Research Ltd, Zurich (CH)

(21) Appl. No.: 12/068,671

(22) Filed: Feb. 8, 2008

Related U.S. Application Data
(63) Continuation of application No. PCT/CH2005/000468, filed on Aug. 10, 2005.

(51) Int. Cl. H01H 33/00

(52) U.S. Cl. 218/149

(57) ABSTRACT

In a self-blast circuit breaker, the inner contact is equipped with a control body which extends into or against the outer contact, respectively. The control body forces the arc into an arcing zone in the form of a hollow cylinder. This achieves a more rapid pressure build up as a result of which the provision of the extinction chamber of the circuit breaker with extinguishing gas can be improved. The gas flow out of and into the arcing zone can be optimized by suitable shaping of the control body.

### RELATED APPLICATION

This application claims priority as a continuation application under 35 U.S.C. §120 to PCT/CH2005/000468 filed as an International Application on 10 Aug. 2005 designating the U.S., the entire content of which is hereby incorporated by reference in its entirety.

### TECHNICAL FIELD

The disclosure relates to a self-blast circuit breaker, e.g., for high or medium voltage.

### BACKGROUND INFORMATION

A self-blast circuit breaker of the known type is described in DE 198 59 764. It has a rod-shaped inner contact (contact pin) and a ring-shaped outer contact (contact tulip). When the circuit breaker is interrupted, gas heated by the arc flows into an extinction chamber from which it is blown back later into the arcing zone and contributes to the extinction of the arc.

In such circuit breakers, the arc removes material from the insulating walls, as a result of which the pressure increases so that heated gas flows into the extinction chamber and can be used later as extinguishing gas.

The pressure build-up P is approximately given by

P=C·L·j²,

where C is a constant, L is the length of the circuit breaker nozzle and j is the current density. The pressure build-up is an important quantity for the interruption of the arc. The length L cannot be arbitrarily increased since it has influence on the breaking speed and breaking energy. The current density, too, is limited toward the top since the inner contact must find space in the arcing zone. In addition, a narrow breaker nozzle allows a smaller number of breaking processes, since the removal of mass leads to an increase in cross section which has a great effect percentagewise with small nozzle cross sections.

An alternative possibility for extinguishing the arc is described in U.S. Pat. No. 6,207,919, U.S. Pat. No. 6,215,082 and U.S. Pat. No. 6,281,460. In the medium-voltage circuit breakers described in these documents, an end piece designated as “trailing end portion” is arranged at the inner contact, which enters into the arcing zone when the circuit breaker is interrupted.

EP 0 524 088 A1 discloses a self-blast circuit breaker having a body manufactured from insulating material. This body is inserted into an inner arcing contact. This body has the purpose whereby, when the self-blast circuit breaker is opened, the inner space of the insulating nozzle essentially remains closed until the control body has passed the narrowest point on the insulating nozzle. After that, the extinguishing gas can flow unimpeded through the clear diameter of the insulating nozzle.

### SUMMARY

The object is to provide a circuit breaker of the type initially mentioned, having a good breaking characteristic.

A self-blast circuit breaker with an inner contact and an outer contact is disclosed, wherein the outer contact is arranged around a center axis of the inner contact, wherein, with the circuit breaker switched on, the outer contact is in contact with a contact area of the inner contact, wherein, for interrupting the circuit breaker, the inner contact and/or the outer contact can be moved along an axis, in such a manner that an arcing zone is produced between the contacts, and with an extinction chamber which is in contact with the arcing zone via at least one extinction duct, in such a manner, that gas can be moved to and fro between the arcing zone and the extinction chamber, wherein at the inner contact, a control body insulated from the contacts is arranged which extends from the contact area of the inner contact along the axis toward or into the outer contact, respectively, and wherein the arcing zone extends around the control body, wherein the control body has a first section having a first diameter and a second section having a second diameter different than the first diameter, wherein the second section is arranged on a side of the first section facing the inner contact, in such a manner that when the circuit breaker is interrupted, first the second section and then the first section reaches a mouth of the extinction duct.

A self-blast circuit breaker with an inner contact and an outer contact is disclosed, wherein the outer contact is arranged around a center axis of the inner contact, wherein, with the circuit breaker switched on, the outer contact is in contact with a contact area of the inner contact, wherein, for interrupting the circuit breaker, the inner contact and/or the outer contact can be moved along an axis, in such a manner that an arcing zone is produced between the contacts, and with an extinction chamber which is in contact with the arcing zone via at least one extinction duct, in such a manner, that gas can be moved to and fro between the arcing zone and the extinction chamber, wherein at the inner contact, a control body insulated from the contacts is arranged which extends from the contact area of the inner contact along the axis toward or into the outer contact, respectively, and wherein the arcing zone extends around the control body, wherein in the control body, at least one discharge duct for supplying and/or removing gas into/out of the arcing zone is arranged.

### BRIEF DESCRIPTION OF THE DRAWINGS

Further embodiments, advantages and applications of the disclosure are found in the description which now follows, referring to the figures, in which:

FIG. 1 shows a section through an exemplary circuit breaker in the switched-on state,

FIG. 2 shows the circuit breaker according to FIG. 1 in a first phase during interruption of the circuit breaker,

FIG. 3 shows the circuit breaker according to FIG. 1 in a second phase during interruption of the circuit breaker,

FIG. 4 shows a second exemplary embodiment of a circuit breaker,

FIG. 5 shows a third exemplary embodiment of a circuit breaker,

FIG. 6 shows a fourth exemplary embodiment of a circuit breaker and

FIG. 7 shows a fifth exemplary embodiment of a circuit breaker.

### DETAILED DESCRIPTION

This object is achieved by the circuit breaker as summarized. For this purpose, a control body insulated from the contacts is arranged at the inner contact (contact pin). It extends from the contact area of the inner contact along the axis of the contacts against or into the outer contact (contact tulip). The arcing zone produced when the circuit breaker is interrupted surrounds the control body. The arcing zone thus has the approximate shape of a hollow cylinder which improves the transmission of energy to the walls. The energy can be delivered both to the inner wall (i.e. the control body) and to the outer wall. This halves the radiation load on the walls with a given arc intensity.

The wall material removal rate dm/dt is given by

dm/dt=υ·U·I/h,

where υ is the proportion of arc energy impinging on the walls, h is the evaporation enthalpy of the insulating wall material and U and I are the voltage and the current. υ greatly depends on the temperature profile of the arc and on the gas temperature outside the arc and the material in which the arc is burning. Typical values of υ are 0.5 for conventional circuit breakers, whereas U is much greater for a hollow-cylindrical arcing zone. Material can thus be removed, and pressure built up, more rapidly. As well, the removal of material occurs on two walls as a result of which the rate of removal can be increased. However, the geometric change of the arcing chamber associated with the removal of material is relatively small, seen as a percentage, so that the life of the circuit breaker is long.

In the arrangement according to the disclosure, the contact areas can have a large diameter without increasing the diameter of the breaker nozzle, and thus the pressure loss. Large contact diameters are more resistant to contact erosion.

The cooling of the arc is also improved.

The use of such a system in a self-blast circuit breaker with extinction chamber leads to important synergies. Whereas in the systems according to U.S. Pat. No. 6,207,919, U.S. Pat. No. 6,215,082 and U.S. Pat. No. 6,281,460, the “trailing end portion” is lastly only used for extinguishing the arc, the control body is used in the present disclosure for modifying the shape of the arcing zone so that a high pressure is achieved which allows the extinction chamber to be charged up efficiently. The arc is extinguished by the gas coming from the extinction chamber.

The control body can have sections having different diameters which are guided past the mouth of the extinguishing duct when the circuit breaker is interrupted. As a result, the control body acts as variable valve and the flow resistance between arcing zone and extinction chamber and in the axial direction can be varied in dependence on time, which allows a further optimization of the process.

The arrangement of a magnetic field source for generating a magnetic field in the arcing zone is also advantageous. This magnetic field must be arranged in such a manner that it has a radial component with respect to the axis of the circuit breaker in the arcing zone, so that the charged particles of the arc are deflected transversely with respect to the axis. As a result, the charged particles can be forced onto helical paths which increases the effective length of the arc and improves the breaking capacity.

In a further exemplary embodiment, a material having a dielectric constant of ε>>1, particularly a ferroelectric material, is arranged in the control body. This makes it possible to influence the course of the field when the circuit breaker is interrupted. In particular, peaks in the field can be avoided.

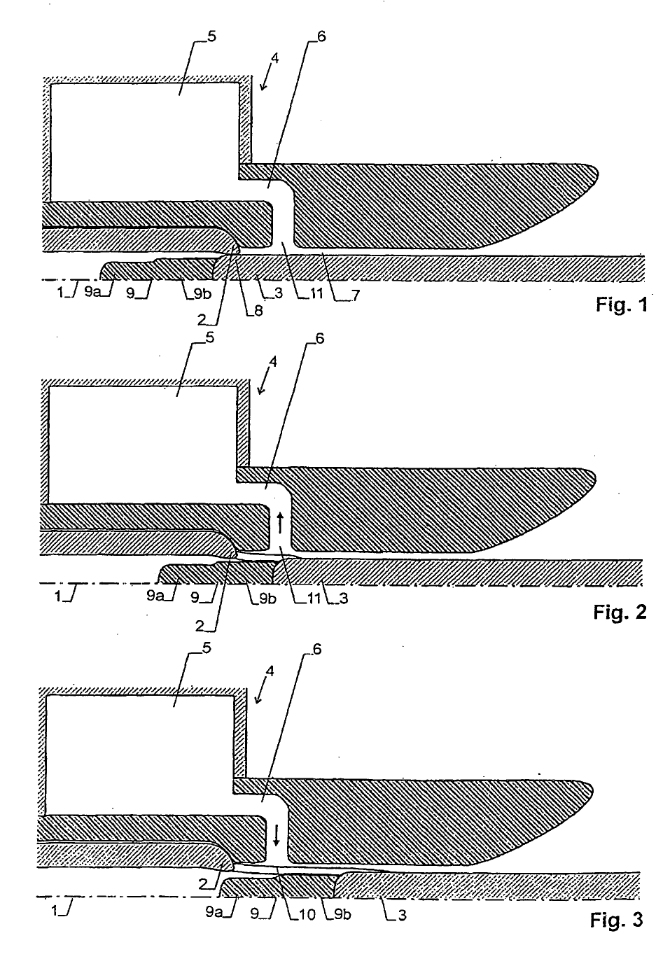

The exemplary embodiments shown in the figures are in each case constructed essentially rotationally symmetrically about their axis 1, which is why in each case only one half of the respective section is shown. FIG. 1 shows a first exemplary embodiment of the circuit breaker in the switched-on (i.e. conductive) state. The circuit breaker has an (as a rule) moving, first or outer contact 2 (contact tulip) which extends annularly around the axis 1, and a (as a rule) resting second or inner contact 3 (contact pin) which, as a rule, is constructed to be rod-shaped or tube-shaped. The two contacts 2, 3 can be displaced relatively to one another in the axial direction. The outer contact 2 is arranged annularly around the center axis (axis 1) of the inner contact 3.

Around the contacts 2, 3, a circuit breaker body 4 is arranged in which an extinction chamber 5 is provided. As shown in FIG. 1, the extinction chamber 5 can be a simple chamber with a fixed volume. As is known from the prior art, however, it can also have a variable volume. Its volume can be reduced during the interrupting of the circuit breaker in order to improve the pressure build-up, particularly when switching low currents.

The extinction chamber 5 communicates via an extinction duct 6 in the insulating nozzle with an inner space 7 of the circuit breaker body 4 in which, when the circuit breaker is interrupted, an arcing zone described below is produced.

In the switched-on state according to FIG. 1, a contact area 8 of the inner contact 3 is connected to the outer contact 2.

According to the disclosure, a control body 9 is arranged at the inner contact 3. It extends from the contact area 8 of the inner contact 3 along the axis 1. In the switched-on state of the circuit breaker, it extends into the outer contact 2. In the interrupted state of the circuit breaker, which will be described further below, it still extends into the outer contact 2, depending on length, or at least from the inner contact 3 toward the outer contact 2.

The control body 9 preferably consists, at least on its outside, of the same insulating material as the insulating nozzle or the inside of the circuit breaker body 4. For this purpose, a synthetic material can be used, in particular PTFE. In the exemplary embodiment of FIG. 1, the entire control body 9 consists of PTFE. The use of synthetic material, in particular PTFE, has the advantage that material removed by the arc contributes to the abovementioned pressure build-up and can be used as extinguishing gas.

In the exemplary embodiment according to FIG. 1, the control body 9 has two sections 9a, 9b having different diameters. The first section 9a has a first diameter and is located at the end of the control body 9 facing away from the inner contact 3. The second section 9b has a second diameter which is greater than the first diameter. It is arranged at the side of the first section 9a facing toward the inner contact 2.

The operation of the circuit breaker of FIG. 1 is disclosed by the switching-off process shown in FIGS. 2 and 3.

To interrupt or switch off the circuit breaker, the outer contact 2 with the circuit breaker body 4 is pulled along the axis 1 away from the inner contact 3 with the control body 9. During this process, an arcing zone 10 is produced between the contacts as shown in FIGS. 2 and 3. The arcing zone 10 extends around the control body 9 and thus has the approximate shape of a hollow cylinder. It is bounded by the inside of the circuit breaker body 4 toward the outside and by the control body 9 toward the inside. The arc removes material from both bodies, which leads to a pressure build-up. Since the mouth 11 of the extinguishing duct 6 is arranged at the arcing zone 10, gas can flow from the arcing zone 10 into the extinction chamber 5.

During the first phase, shown in FIG. 2, in the interruption of the circuit breaker, the second section 9b of the control body 9 is located in the area of the arcing zone 10 and of the outer contact 2. As a result, the flow resistance is relatively high in the axial direction away from the arcing zone 10 and particularly past the contact area of the outer contact 2, so that the pressure build-up in the arcing zone 10 is correspondingly high and the pressure discharges primarily into the extinction chamber 5.

If the inner contact 3 is moved further, the first section 9a of the control body 9 comes into the area of the mouth 11 as is shown in FIG. 3. Since the first section 9a has a smaller diameter than the second section 9b, the flow resistance from the arcing zone 10 is reduced in the axial direction against the first contact 2, as is the flow resistance in the area of the mouth 11, which facilitates the flow of extinguishing gas back into the arcing zone 10 which now starts. The extinguishing gas cools down the arc and the current is interrupted.

Thus, the gas pressure build-up can be supported due to the deliberately selected variation in diameters of the control body. At the same time, the metal vapor in the heating volume can be reduced by impairing the flow of metal vapor from the electrodes into the extinction chamber 5.

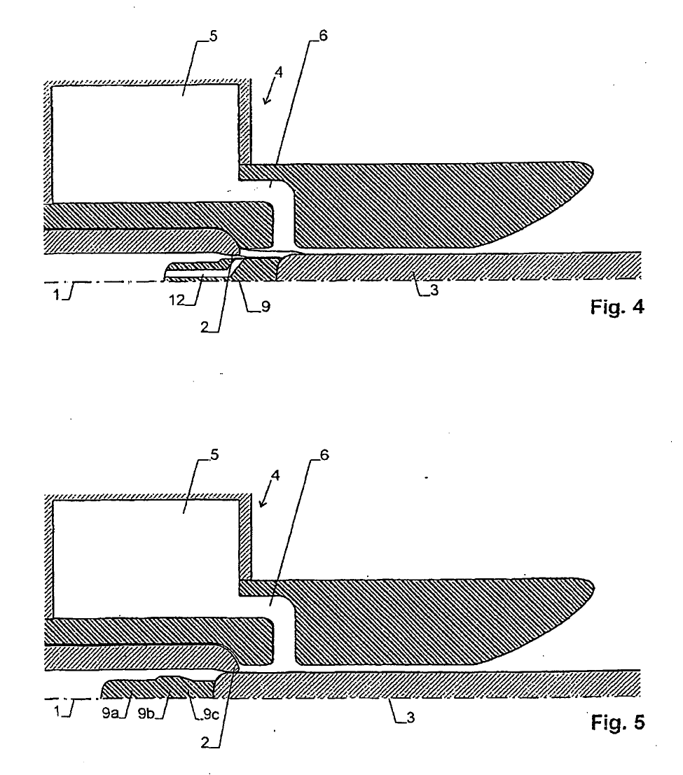

In the exemplary embodiment according to FIGS. 1 to 3, the gas flow into and out of the arcing zone 10 was controlled by means of the shaping of the surface of the control body 9. However, it is also conceivable to arrange one or more discharge ducts 12 in the control body 9, as is shown in the second exemplary embodiment according to FIG. 4. Having such discharge ducts 12 which, e.g., may have the form of tunnels or grooves in the control body 9, it becomes possible to deliberately remove gas from individual areas of the arcing zone 10 at particular times in the switching-off process.

A further variant of the circuit breaker is shown in FIG. 5. The control body 9 here additionally has a third section 9c which is arranged on the side of the second section 9b facing the inner contact 3. The diameter of the third section is smaller than that of the second section 9b. This exemplary embodiment is mainly suitable for high currents, in the case of which a rapid pressure build-up can take place at the beginning of the interruption process when the third section 9c is in the area of the mouth 11. In a next phase, the second section (which can have a somewhat larger diameter than that according to FIGS. 1-3) is in the area of the mouth 11 and impairs an early emergence of the extinguishing gas. In a last phase, the first section 9a reaches the mouth so that the extinguishing gas can emerge virtually unimpeded and extinguish the arc.

In the embodiments previously shown, the gas flow into and out of the arcing zone 10 is controlled in dependence on time by means of the shaping of the control body 9, as a result of which the pressure build-up and the extinguishing process can be optimized.

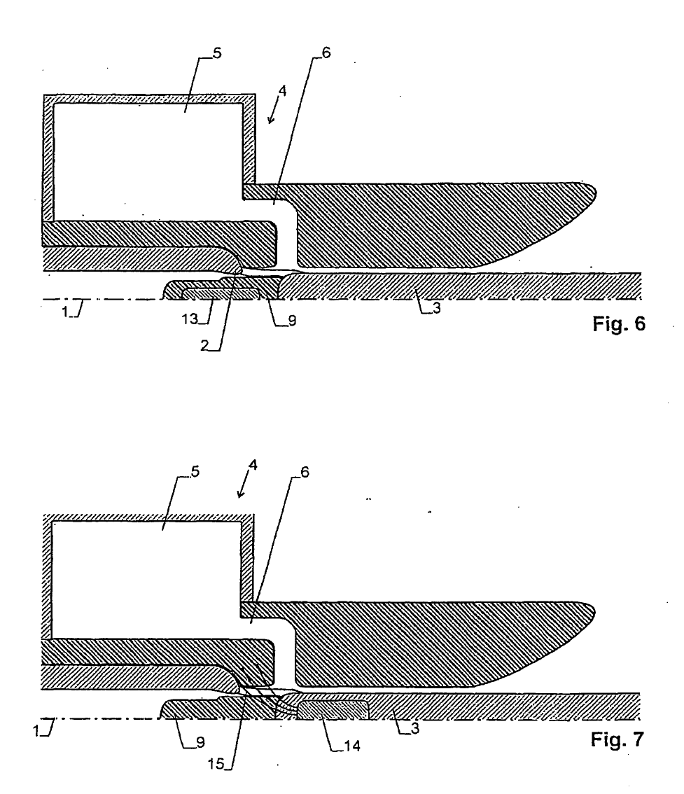

In the exemplary embodiment according to FIG. 6, a material insert 13 with a dielectric constant of ε>>1, e.g. of a dielectric or ferroelectric material, is arranged in the control body 9. It influences the distribution of the electrical field when the arc is extinguished and allows effective field control.

FIG. 7 shows a further exemplary embodiment. In this case, a magnetic field source 14 in the form of a permanent magnet is arranged, e.g. in the inner contact 3. The magnetic field source 14 generates a magnetic field 15, the field lines of which are partially drawn in FIG. 7. The field vectors of this field have a radial component with respect to the axis 1 in the area of the arcing zone 10. This has the effect that the charged plasma particles moving between the inner electrode 3 and the outer electrode 2 are accelerated in a tangential direction (i.e. perpendicularly to the axis 1 and perpendicularly to its radial), as a result of which the particles, as already explained initially, are forced onto a helical path around the control body 11. This extends the effective length of the arc, which facilitates its extinction.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE DESIGNATIONS

1 Axis

2 First contact, outer contact (e.g. contact tulip)

3 Second contact, inner contact (e.g. contact pin)

4 Circuit breaker body (incl. insulating nozzle)

5 Extinction chamber

6 Extinction duct

7 Inner space

8 Contact area

9 Control body

9a First section

9b Second section

9c Third section

10 Arcing zone

11 Mouth

12 Discharge duct

13 Material with ε>>1, dielectric

14 Magnetic field source

15 Magnetic field

What is claimed is:

1. A self-blast circuit breaker with an inner contact and an outer contact, wherein the outer contact is arranged around a center axis of the inner contact, wherein, with the circuit breaker switched on, the outer contact is in contact with a contact area of the inner contact, wherein, for interrupting the circuit breaker, the inner contact and/or the outer contact can be moved along an axis, in such a manner that an arcing zone is produced between the contacts, and with an extinction chamber which is in contact with the arcing zone via at least one extinction duct, in such a manner, that gas can be moved to and fro between the arcing zone and the extinction chamber, wherein at the inner contact, a control body insulated from the contacts is arranged which extends from the contact area of the inner contact along the axis toward or into the outer contact, respectively, and wherein the arcing zone extends around the control body, wherein the control body has a first section having a first diameter and a second section having a second diameter different than the first diameter, wherein the second section is arranged on a side of the first section facing the inner contact, in such a manner that when the circuit breaker is interrupted, first the second section and then the first section reaches a mouth of the extinction duct.

2. The self-blast circuit breaker as claimed in claim 1, wherein when the circuit breaker is interrupted, the extinction duct opens into the arcing zone arranged around the control body.

3. The self-blast circuit breaker as claimed in claim 1, wherein the control body has a third section having a third diameter which is smaller than the second diameter, wherein the third section is arranged on a side of the second section facing the inner contact.

4. The self-blast circuit breaker as claimed in claim 1, wherein an outside of the control body is of synthetic material, particularly PTFE.

5. The self-blast circuit breaker as claimed in claim 1, wherein an outside of the control body consists of the same material as an inside of a circuit breaker body surrounding the arcing zone.

6. The self-blast circuit breaker as claimed in claim 1, characterized by a magnetic field source for generating a magnetic field in the arcing zone, wherein the magnetic field has a radial component with respect to the axis in the arcing zone, in such a manner that charged particles in the arc can be deflected transversely with respect to the axis by means of the magnetic field.

7. The self-blast circuit breaker as claimed in claim 1, wherein a material having a dielectric constant of ε>>1, particularly a ferroelectric material, is arranged in the control body.

8. The self-blast circuit breaker as claimed in claim 1, wherein in the control body, at least one discharge duct for supplying and/or removing gas into/out of the arcing zone is arranged.

9. A self-blast circuit breaker with an inner contact and an outer contact, wherein the outer contact is arranged around a center axis of the inner contact, wherein, with the circuit breaker switched on, the outer contact is in contact with a contact area of the inner contact, wherein, for interrupting the circuit breaker, the inner contact and/or the outer contact can be moved along an axis, in such a manner that an arcing zone is produced between the contacts, and with an extinction chamber which is in contact with the arcing zone via at least one extinction duct, in such a manner, that gas can be moved to and fro between the arcing zone and the extinction chamber, wherein at the inner contact, a control body insulated from the contacts is arranged which extends from the contact area of the inner contact along the axis toward or into the outer contact, respectively, and wherein the arcing zone extends around the control body, wherein in the control body, at least one discharge duct for supplying and/or removing gas into/out of the arcing zone is arranged.

10. The self-blast circuit breaker as claimed in claim 2, wherein the control body has a third section having a third diameter which is smaller than the second diameter, wherein the third section is arranged on a side of the second section facing the inner contact.

11. The self-blast circuit breaker as claimed in claim 3, wherein an outside of the control body is of synthetic material, particularly PTFE.

12. The self-blast circuit breaker as claimed in claim 4, wherein an outside of the control body consists of the same material as an inside of a circuit breaker body surrounding the arcing zone.

13. The self-blast circuit breaker as claimed in claim 5, characterized by a magnetic field source for generating a magnetic field in the arcing zone, wherein the magnetic field has a radial component with respect to the axis in the arcing zone, in such a manner that charged particles in the arc can be deflected transversely with respect to the axis by means of the magnetic field.

14. The self-blast circuit breaker as claimed in claim 6, wherein a material having a dielectric constant of ε>>1, particularly a ferroelectric material, is arranged in the control body.

15. The self-blast circuit breaker as claimed in claim 7, wherein in the control body, at least one discharge duct for supplying and/or removing gas into/out of the arcing zone is arranged.
